(19) United States
(12) Patent Application Publication
(10) Pub. No.: US 2019/0102788 A1
(43) Pub. Date: Apr. 4, 2019

(54) PERISHABLE PRODUCT CONSERVATION SYSTEM

(71) Applicant: Walmart Apollo, LLC, Bentonville, AR (US)

(72) Inventors: Steven Lewis, Bentonville, AR (US); Nicholaus A. Jones, Fayetteville, AR (US); Matthew Biermann, Fayetteville, AR (US); Richard Montgomery Blair, II, Bentonville, AR (US); William Ross Allen, Pea Ridge, AR (US); Anjana Devi Nallapati, Bentonville, AR (US)

(21) Appl. No.: 16/151,681

(22) Filed: Oct. 4, 2018

Related U.S. Application Data
(60) Provisional application No. 62/567,807, filed on Oct. 4, 2017.

(51) Int. Cl. G06Q 30/02; G06Q 10/08

(52) U.S. Cl. CPC G06Q 30/0223; G06Q 30/0206; G06Q 10/087

(57) ABSTRACT

A perishable product conservation system and related methods for foods and consumable products. One system includes a plurality of perishable products, a perishable product database, and a computing system. The perishable product database includes a plurality of product records for the plurality of perishable products. Each of the plurality of product records includes expiration date information and a current product location. The computing system is communicatively coupled with the perishable product database and includes a customer preference engine, a markdown engine, and a computing device. The customer preference engine is configured to identify a desired perishable product, a desired location for receiving purchases, and a set of customer tolerances for the desired perishable product including a desired expiration date range. The markdown engine is configured to provide dynamic pricing for the desired perishable product, available within the desired expiration date range.

### RELATED APPLICATION

The present application claims the benefit of U.S. Provisional Application No. 62/567,807 filed Oct. 4, 2017, which is hereby incorporated herein in its entirety by reference.

Embodiments relate generally to retail systems involving perishable products, and more particularly, to systems and methods providing conservation of perishable products via flexible product offerings, dynamic pricing, and alerts to consumers based on perishable product information including expiration date information.

### BACKGROUND

Buying and selling perishable products, such as groceries and fresh or packaged food items, present a number of problems and challenges to both retailers and customers. One challenge to retailers is to efficiently sell perishable products while they are fresh and before they are deemed spoiled or otherwise unusable. Similarly, quickly delivering these items to areas they are in demand presents an associated challenge to retailers as well. One contributing factor is the difficulty of pricing of these items to properly account for expiration dates. Moreover, properly targeting and motivating consumer purchasing behavior when expiration dates are approaching can be difficult.

One problem of consumers is the lack of visibility of information available regarding perishable products and pricing without physically inspecting these items and prices in person. Customers are generally unaware of discounted perishable items based on expiration date unless they are physically present in a store with the items. Also, customers typically have very few choices with regard to the freshness of perishable items and are restricted to selecting those present at a store at a given time. Flexibility is limited to customers as well, as purchasing perishable goods based on significantly different freshness, expiration dates, or similar limitations is not an option. The result is that inefficient and wasteful delivery systems are common for perishable goods.

Accordingly, a system with the ability to efficiently sell perishable products to avoid waste and with greater flexibility would be extremely useful to retailers and improve the experience of retail customers. Therefore, new systems and methods enabling more effective, efficient, and flexible perishable product offerings and sales are needed.

### SUMMARY

Various embodiments of systems and method are set forth which leverage expiration dates and other information regarding perishable goods via mobile apps, websites, and the like, to conserve and efficiently handle perishable products for the benefit of customers and retailers in the supply chain. Various embodiments disclosed generally relate to supply chain dynamic pricing and options for perishable products. Some of these more specifically relate to a mobile application that alerts customers when perishable items, like fresh cuts of meat, are marked down at a customer's local store, for example.

In an embodiment, a perishable product conservation system for foods and consumable products includes a plurality of perishable products in inventory, a perishable product database, and a computing system. The perishable product database includes a plurality of product records for the plurality of perishable products. Each of the plurality of product records includes expiration date information and a current product location. The computing system is communicatively coupled with the perishable product database and includes a customer preference engine, a markdown engine, and a computing device. The customer preference engine is configured to identify a desired perishable product, a desired location for receiving purchases, and a set of customer tolerances for the desired perishable product including a desired expiration date range. The markdown engine is configured to provide dynamic pricing for the desired perishable product, available within the desired expiration date range, based on at least: the expiration date information, the current product location, and a shipping cost for transporting the perishable product to the desired location for receiving purchases. The computing device communicatively interfaces with the customer preference engine and the markdown engine. The computing device has hardware including at least one processor, a memory operably coupled to the at least one processor and configured to store instructions invoked by the at least one processor, an operating system implemented on the computing hardware, and a display generator for a customer interface configured to store a plurality of renderable structures defining a display of one or more user interface elements of a client interface, the display generating dynamic pricing information and graphics.

In some embodiments, the customer preference engine relies on stored information from: a set of saved customer selected preferences, a set of saved past purchase information, or a set of customer preferences determined based on machine learning specific to a specific customer.

In some embodiments, the perishable product conservation system includes an alert engine configured to monitor the perishable product database and generate an alert based on satisfaction of the set of customer tolerances and the dynamic pricing for the desired perishable product.

In an embodiment, a method of providing dynamically discounted perishable foods and consumable products includes providing a perishable product database comprising a plurality of product records for a plurality of perishable products held in inventory, each of the plurality of product records including expiration date information and a current product location. The method further including providing a computing system, including a customer preference engine, a markdown engine, and a computing device, communicatively coupled with the perishable product database. The method further including receiving a customer request in the customer preference engine for a desired perishable product, a desired location for receiving purchases, and a set of customer tolerances for the desired perishable product including a desired expiration date range. The method further including searching the perishable product database for perishable products corresponding to the desired perishable product that meet the set of customer tolerances. The method further including calculating a dynamic price with the markdown engine for the desired perishable product including a cost to ship the desired perishable product to the desired location. The method further including presenting the dynamic price of the desired perishable product with an option to purchase on the computing device.

In some embodiments, the method includes enabling customer modification and storage of a set of customer selected preferences for: the desired perishable product, the desired location for receiving purchases, the set of customer tolerances for the desired perishable product including the desired expiration date range, and price.

In some embodiments, the method includes establishing an alert engine to monitor the perishable product database and generating an alert when the customer selected preferences are satisfied.

The above summary is not intended to describe each illustrated embodiment or every implementation of the subject matter hereof. The figures and detailed description that follow more particularly exemplify various embodiments.

### BRIEF DESCRIPTION OF THE DRAWINGS

Subject matter hereof may be more completely understood in consideration of the following detailed description of various embodiments in connection with the accompanying figures.

FIG. 1 is a schematic diagram of a perishable product conservation system according to an embodiment.

FIG. 2 is a flowchart of a method of providing dynamically discounted perishable foods and consumable products according to an embodiment.

FIG. 3 is a schematic diagram of a perishable product conservation system according to an embodiment.

FIG. 4 is a flowchart of a method of providing dynamically discounted perishable foods and consumable products according to an embodiment.

FIG. 5 is a schematic diagram of a perishable product conservation system according to an embodiment.

FIG. 6 is a schematic diagram of a perishable product conservation system including alerting according to an embodiment.

FIG. 7 is a flowchart of a method of providing dynamically discounted perishable foods and, specifically, a markdown and alert system for fresh cut meats according to an embodiment.

FIG. 8 is a flowchart of a method of providing dynamically discounted perishable foods and, specifically, a markdown and alert system for fresh cut meats according to an embodiment.

While various embodiments are amenable to various modifications and alternative forms, specifics thereof have been shown by way of example in the drawings and will be described in detail. It should be understood, however, that the intention is not to limit the claimed inventions to the particular embodiments described. On the contrary, the intention is to cover all modifications, equivalents, and alternatives falling within the spirit and scope of the subject matter as defined by the claims.

### DETAILED DESCRIPTION

Embodiments relate to systems and methods for perishable product conservation including dynamic discounting of perishable foods and consumable products and related alerts in view of expiration information. In various embodiments, systems and methods can make use of a mobile app or website to identify and/or be alerted to desirable pricing of perishable products based on expiration date information, location information, and other criteria.

Embodiments can include a variety of systems and methods, including use of mobile apps, websites, and other interfaces to provide a wide range of embodiments and corresponding features. For example, in some embodiments, a system alerts a customer of perishable product markdowns based on the customer's preferences. In some embodiments, a system presents dynamic prices for perishable items to a customer based on at least an expiration date and a shipping cost. In some embodiments, a system generates an alert indicating a reduction or discount in perishable food price. In some embodiments, a system calculates (e.g., using min, max, mode and average values) expiration dates for perishable products in inventory, such as at distribution centers and presents them to a customer (e.g., in a drop down menu). In some embodiments, a system considers a customer's location and the location of a distribution center or other facility where a perishable product is currently located to determine shipping time and price. In some embodiments, a system considers the cost of disposing of the perishable item if it cannot be sold before or by its expiration date. In some embodiments, a system considers a plurality of factors to determine pricing of a perishable product (e.g., time, expiration, distance, quantity, and need of the customer). In some embodiments, a system generates an alert based on a customer's preferences and markdown type, price, or location. In some embodiments, the alert can include a photo of the perishable item so that the customer can review it. In some embodiments, a system calculates an average time for selling or ordering the perishable product based on historical data. In some embodiments, a system analyses data through a feedback loop and uses it for self-learning. In some embodiments, a system uses self-learning information to provide annual or rolling perishable product ordering for customers to optimize inventory management and meet customer needs and preferences. These and numerous other embodiments and related methods are contemplated, many of which will be more specifically discussed in the following detailed description.

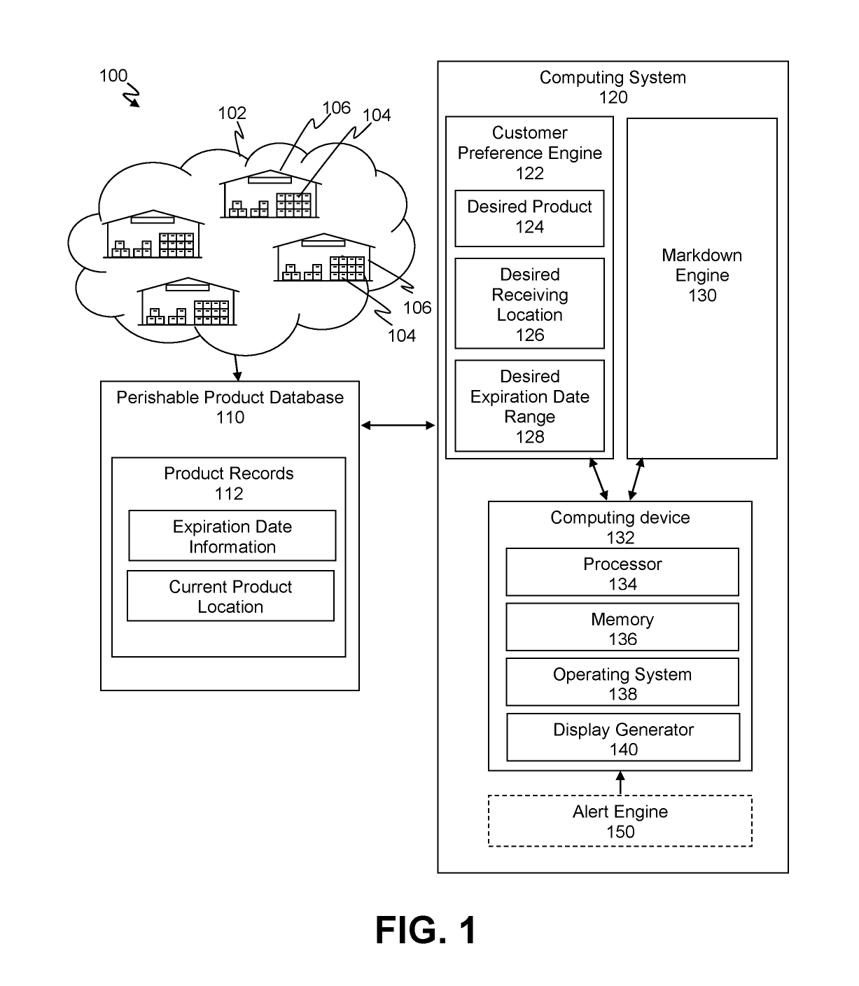

FIG. 1 depicts embodiments of a perishable product conservation system 100 providing dynamic pricing of a distributed inventory 102 of perishable products 104 found in various locations 106. As shown in FIG. 1, perishable product conservation system 100 comprises a plurality of perishable products 104 held in inventory 102, a perishable product database 110, and a computing system 120 having a customer preference engine 122, a markdown engine 130, and a computing device 132. An alert engine 150 can be included as part of the computing system 120 in various embodiments as well.

Perishable products 104 include any perishable food item such as produce, meats, or packaged goods having expiration dates. Some perishable products 104 may typically have a short period until expiration, such as fresh fruit or cuts of meat, while others may have relatively long periods until expiration, such as canned goods, for example. Perishable products 104 include packaged food products and non-food items as well that have a limited lifespan and expiration date. The wide range of perishable products 104 can include fresh fruit, baby formula, soft drinks, or batteries, for example.

Determinations of expiration date information for a particular perishable product 104 varies greatly based upon the type of item, rate of spoliation, climate, or exposure to light temperature or air, among other factors. The particulars of a system used to acquire expiration data from the products 104 themselves is not provided in detail in this application, but could use any of a number of known methods and techniques. For example, acquiring expiration information can be part of inventory management tools for stores, distribution centers, or other supply chain locations.

Perishable products 104 are only generally referenced in the diagram of FIG. 1. The diagram merely references the products 104 themselves as well as their respective locations 106 as part of inventory 102. Locations 106 of perishable products 104 in inventory 102 can include warehouses, stores, retail environments, distribution centers, vehicles in transit, retail outlets, physical brick-and-mortar storefronts, or other commercial, storage, or supply chain location. Locations 106 can further merely be a reference to a city or other physical geo-location, a set of coordinates, or store/warehouse ID.

The product locations 106 can be associated with a retailer, such as by being a subsidiary, franchise, outlet, or other affiliate of the retailer. The retailer can be or have a home office or headquarters of a company, or some other affiliate, which often is located apart from the retail environment itself. In some embodiments, facilities or functions associated with the broader retailer can be partially or fully co-located with the retail environment. At times in this application, the terms “store,” “retailer,” and “retail environment” are used interchangeably herein. Some product locations 106 may be storage/transit locations while others may also be potential product receiving locations for customers.

The perishable product database 110, as shown in FIG. 1, includes a plurality of product records 112 for a plurality of perishable products 104 held in inventory in one of the locations 106. Each of the plurality of product records 112 includes, at least, expiration date information 114 and a current product location 116. The perishable product database 110 may be made up of one or multiple parts, may utilize hardware in one or multiple locations and/or be distributed across a cloud environment. Expiration date information 114 may be date information corresponding to one or more of: a “Sell-By” date, a “Sell-Before” date, a “Best-By” date, a “Best-Before” date, a “Best-If-Used-By” date, a “Best-If-Used-Before” date, a “Use-By” date, or a “Use-Before” date. Expiration date information 114 can include one or more of: a minimum value, a maximum value, a mode, an average value, or a combination thereof. Expiration date information 114 can include any metric used to convey a temporal limit on product life or usefulness. It is contemplated that an alternate or more uniform expiration date metric or nomenclature can be developed or applied and used as part of this system.

Information regarding the current product location 116 can include identification of a warehouse, store, retail environment, distribution center, vehicles in transit, retail outlet, physical brick-and-mortar storefront, commercial or storage setting, a city, a region, a sector, other physical geo-location, or a set of coordinates. In some embodiments, products or groups of products will have GPS identifiers, RFID tags, or other location tracking elements to determine the current product location 116.

In some embodiments, the product records 112 for the plurality of perishable products 104 held in inventory include other information as well. For example, the product records 112 may include a recent photo of the perishable product(s) 104. These photos can be regularly updated and kept up to date in certain embodiments. In some embodiments, the product records 112 can include the storage environment of the items (i.e. frozen, refrigerated, etc.). Product records 112 may also include specific instructions, or notes related to a perishable product 104. Product records 112 may also include a product status, such as a measure or metric of produce ripeness, for example.

Computing system 120 is communicatively coupled with the perishable product database 110. The computing system 120 can utilize different hardware structures and take on various forms. In general, computing system 120 includes at least a customer preference engine 122, a markdown engine 130, and a computing device 132. Each of these components of the computing system 120 are communicatively coupled with the others. In some embodiments, the customer preference engine 122 or markdown engine 130 will entirely or primarily be processed by different hardware from the computing device 132. In these cases, the customer preference engine 122 or markdown engine 130 will include a processor, memory and other electric circuitry, for example. In some embodiments, the customer preference engine 122 or markdown engine 130 will be processed by or share processing with the computing device 132.

The customer preference engine 122 is configured to identify a desired perishable product 124, a desired location 126 for receiving purchases, and a set of customer tolerances for the desired perishable product 124 including a desired expiration date range 128. Insertion of data parameters into the customer preference engine 122 can typically be done via customer interface with a mobile application or website. For example, a customer may visit a website for the retailer and complete a form of fill in the blank or drop down customer preferences. Alternatively, preferences can be similarly filled out by a customer using an app for the retailer. In some embodiments, a customer enters and saves a set of desired preferences (i.e. desired product, desired receiving location, desired expiration date range, etc.) for future and ongoing searches and notifications. In some embodiments, a customer enters desired preferences as a one-time search. In some embodiments, customer preferences are determined based on past searches and purchases. In some embodiments, customer preferences are based upon machine learning about customer behavior and tendencies. Accordingly, in some embodiments, the customer preference engine 122 relies on stored information from: a set of saved customer selected preferences, a set of saved past purchase information, or a set of customer preferences determined based on machine learning specific to a specific customer.

The desired perishable product 124 may be any perishable product and may correspond to a perishable product 104 in inventory in some cases. The desired receiving location 126 may be a store, distribution center, or other commercial location that would allow customer pick-up of purchased goods. The set of customer tolerances may be any of a number of limitations by which the customer wishes to limit his or her search. These can include produce ripeness or desired expiration range 128, for example. Desired expiration date range 128 can include an “expires after” date, a range of acceptable expiration dates, or an “expires in less than one week” date, for example.

Markdown engine 130 is configured to provide dynamic pricing for products meeting the requirements of the customer preference engine 122. Further, the markdown engine 130 takes into account a plurality of pieces of information that impact pricing. Specifically, the markdown engine 130 is configured to provide dynamic pricing via a specialized algorithm for the desired perishable product 124, available within the desired expiration date range 128, based on at least: expiration date information 114, current product location 116, and a shipping cost for transporting the perishable product 124 to the desired location 126 for receiving purchases. In general, the markdown engine 130 can be communicatively coupled and run on the same or different hardware as the customer preference engine 122. Shipping costs between locations can be stored and updated or obtained in real-time. Shipping cost can be automatically assigned zero cost when the desired location for receiving purchases matches the current product location. Accordingly, customers can readily receive information (and corresponding alerts) about products already located at a customer's desired store, for example. In some cases, dynamic pricing for desired perishable products will also be based on an expected disposal cost of the desired perishable product. In some cases, dynamic pricing for a desired perishable product is also based on the past sales data of the perishable product or other measure of popularity. In some cases, dynamic pricing for desired perishable products is also based on the current or expected quantity of inventory. In some cases, the dynamic pricing is merely tied to expiration dates. In some cases, dynamic pricing includes a tiered structure of discounted pricing. For example, a tiered structure may have options for tiers such as: full price; discounted price; and fifty percent off price. Each tier could be tied to some expiration date time frame. For example, full prices may be for expiration dates more that three weeks away, discounted prices may be for expiration dates more than one week away but less than three weeks away, and fifty percent off discount prices may apply to expiration dates one week or less away.

Computing device 132 is shown communicatively interfacing with the customer preference engine 122 and the markdown engine 130. The computing device 132 has hardware, including: at least one processor 134, a memory 136, an operating system 138, and a display generator 140. In some embodiments, the computing device is a mobile device, such as a smart phone or tablet device. In some embodiments, the computing device is a laptop or desktop computer. The memory 136 is operably coupled to the at least one processor 134 and configured to store instructions invoked by the at least one processor 134. The operating system 138 is implemented on the computing hardware. Display generator 140 provides a customer interface configured to store a plurality of renderable structures defining a display of one or more user interface elements of a client interface. The display generates dynamic pricing information and graphics. In some cases, tiered pricing options may be displayed. This may include greater prices for products with more distant expiration dates and cheaper prices for products with expiration date in the near future. Accordingly, customers are given option for near maximum price efficiency for the nearest acceptable expiration date. Product conservation is achieved as well as customer cost savings.

In some embodiments, the computing device 132 permits customers to reserve perishable products 104 for later local purchase and pickup. In some embodiments, the computing device 132 permits customers to purchase perishable products 104 directly through the computing system 120. Further, some systems 100 further include actual transportation and shipping of perishable product to desired receiving locations 126 and/or pickup and purchase of those items. In some cases, the desired receiving location is the customer's home residence.

Some embodiments of the computing system 120 further make use of an alert engine 150. An alert engine 150 can be part of the computing system 120 and can even be part of the customer preference engine 122, the markdown engine 130 or computing device 132 in some embodiments. The alert engine 150 serves to inform customers when the requirements for customer preference engine 122 have been met. Specifically, the alert engine 150 can be configured to monitor the perishable product database 110 and generate an alert based on satisfaction of the set of customer tolerances and the dynamic pricing for the desired perishable product. In some embodiments, the alert engine 150 can include a process listener, that monitors the potential perishable product pricing. Various well-known technologies can be used to provide a process listener over the Internet or internal network or inventory management system.

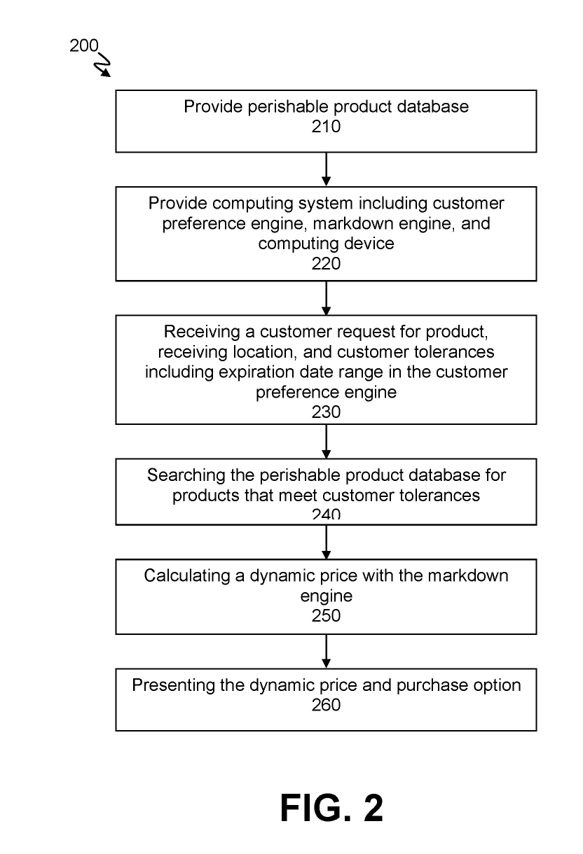

FIG. 2 shows a flowchart of a method 200 of providing dynamically discounted perishable foods and consumable products. It can be understood in relation to the features of FIG. 1, as described, for example. At 210, the method includes providing a perishable product database 110 comprising a plurality of product records 112 for a plurality of perishable products 104 held in inventory 102, each of the plurality of product records 110 including expiration date information 114 and a current product location 116. In some embodiments, the expiration date information 114 includes one or more of: a minimum value, a maximum value, a mode, an average value, or a combination thereof. In some embodiments, the plurality of product records 110 for the plurality of perishable products 104 held in inventory can include a recent photo of the perishable product.

At 220, the method 200 further includes providing a computing system 120, including a customer preference engine 122, a markdown engine 130, and a computing device 132 communicatively coupled with the perishable product database 110. In some embodiments, the computing system 120 utilizes a mobile app. In some embodiments, the computing system 120 utilizes an Internet web site.

At 230, the method 200 further includes receiving a customer request in the customer preference engine 122 for a desired perishable product 124, a desired location 126 for receiving purchases, and a set of customer tolerances for the desired perishable product 124 including a desired expiration date range 128. A customer request may set up a search via customer entered search parameters or based on a customer request via auto-filled data from a set of saved customer parameters.

At 240, the method 200 further includes searching the perishable product database 110 for perishable products 104 corresponding to the desired perishable product 124 that meet the set of customer tolerances. For example, this can include a search for baby formula with expiration date after Jun. 1, 2018.

At 250, the method 200 further includes calculating a dynamic price with the markdown engine 130 for the desired perishable product 124 including a cost to ship the desired perishable product 124 to the desired location 126. In some cases, calculating the dynamic price can include consideration of an expected disposal cost of the desired perishable product 124. In some cases, calculating the dynamic price can include consideration of the past sales data of the desired perishable product 124. In some cases, calculating the dynamic price can include consideration of current or expected quantity of inventory of the desired perishable product 124. In some cases, the cost to ship the desired perishable product 124 is automatically assigned zero cost when the current product location 116 and the desired receiving location 126 match. In these cases, the system simply operates as a price alert system for a given local store or receiving location. Calculating a dynamic price can also include factor in the cost of disposal of the product if unused before expiration, sales history and popularity of the product, and machine learning data. The cost to ship the desired perishable product 124 to a desired location 126 can be determined in various ways. In some cases, a lookup table can be used to identify a price. In some cases, real-time pricing of internal or third party shippers can be queried to determine this amount.

At 260, the method 200 further includes presenting the dynamic price of the desired perishable product 124 with an option to purchase on the computing device 132. In some embodiments, presenting the dynamic price of the desired perishable product 124 includes presenting of a tiered structure of discounted pricing.

In some embodiments, the method 200 can also include enabling customer modification and storage of a set of customer selected preferences for: the desired perishable product 124, the desired location for receiving purchases 126, the set of customer tolerances for the desired perishable product 124 including the desired expiration date range 128, and price.

In some embodiments, the method 200 can also include establishing an alert engine 150 to monitor the perishable product database 110 and generating an alert when customer selected preferences are satisfied.

In some embodiments, the method can include delivery of the perishable product 104 to the desired receiving location 126 and actual purchase.

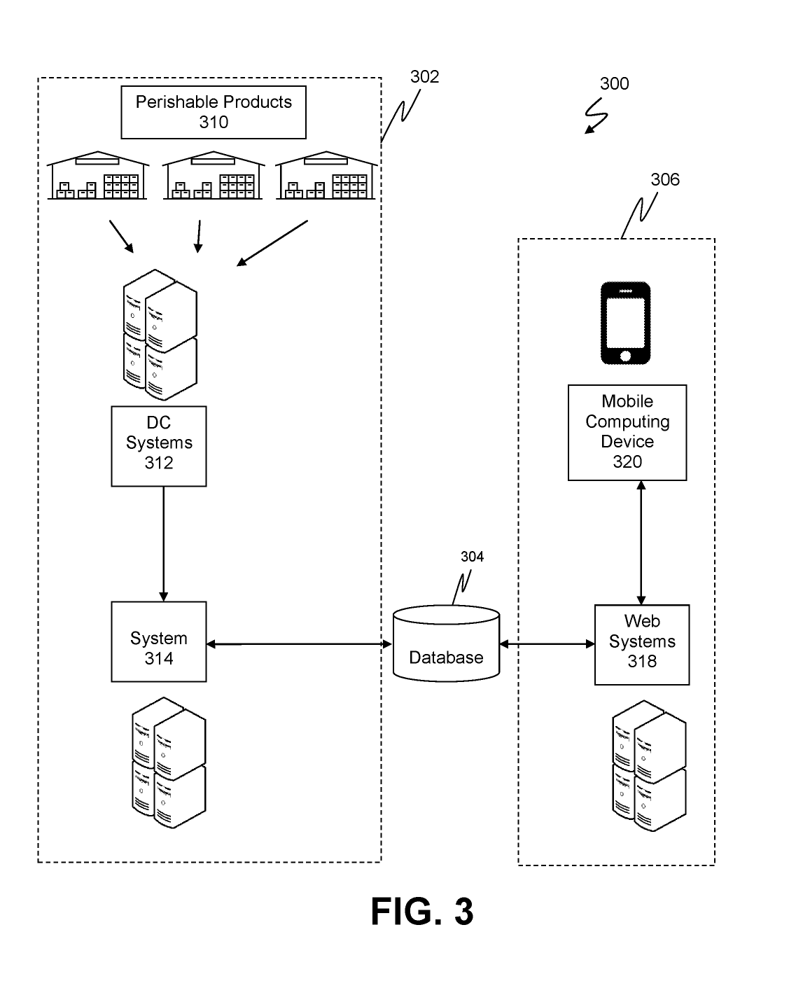

FIG. 3 shows a schematic diagram of a perishable product conservation system 300. System 300 includes a perishable product inventory component 302, a database 304, and a computing system 306. The inventory component 302 includes perishable products 310, DC systems 312, and system 314. The computing system 306 includes web systems 318 and mobile computing device 320. The perishable product conservation system 300 depicts a variation of perishable product conservation system 100 of FIG. 1, but with certain elements called out in more specific detail or in a slightly different way. For example, in certain respects, the perishable products 310, DC systems 312 and system 314 of inventory component 302 corresponds to the distributed inventory 102 of FIG. 1. Likewise, the database 304 roughly corresponds to the perishable product database 110 of FIG. 1. Finally, the web systems 318 and the mobile computing device 320 of the computing system 306 roughly correspond to the computing system 120 of FIG. 1. The systems of FIGS. 1 and 3, and other embodiments herein, should be understood to be adapted or reconfigured with respect to one another.

In FIG. 3, the perishable products 310 at various locations are shown. The distribution center (DC) systems 312 are shown which provide expiration dates and locations for perishable products. DC systems 312 can utilize computing hardware, processing, storage and electrical circuitry of one or more computing systems. The expiration date and location information is transmitted back to a system 314. In various embodiments, the system 312 is equipped to provide, among other things, calculations of minimum (min), maximum (max), mode, and average expiration date values and costs. This information is provided to the database 304. The database 304 serves up values for services to the web systems 318. Web systems 318 then enable a customer using a mobile computing device 320, such as a cell phone, to select and choose perishable products having desired combinations of expiration dates and price. Specifically, the web systems 318 provide expiration values and initially hidden prices and the mobile computing device 320 sends a selection and enables a purchase of the selected perishable product to be made.

Accordingly, a system 300 can operate according to the following sequence, when parameters are being entered from a mobile computing device 320, for example. First, the system 300 displays an expiration drop down on a mobile computing device 320 when a customer is buying a perishable product based on inventory from distribution centers, that is reflected in the DC systems 312. The values displayed on the mobile computing device 320 come from a calculation which takes into account the min, max, mode an average values from system 314. The average value is the nearest actual value just over the average. The system 300, precalculates how much it would cost to ship each perishable product 310 to the customer based on parameters such as customer location, DC location where the products are currently located, and as well as the cost of potentially throwing out products that are closer to their expiration. Determination of implementing these calculations is adjustable depending on customer behavior towards selecting the most distant expiration every time. The customer is then able to make a selection on the mobile computing device 320 based on the presented pricing, and the ability to proceed with ordering.

In other cases, the system 300 will present options on the mobile computing device 320 to the customer based on inventory across the supply chain and present the expiration dates as well as ship timing and price. In general, as one value is adjusted, price falls out, followed by ship timing. In some embodiments, the system 300 should be understood to include operations and equipment involved in the delivery and purchasing of the actual perishable products as well. The system 300 can permit ordering twelve month or rolling supply in advance. The system 300 then leverages the knowledge of the consistent purchases over time to optimize inventory across the chain. The system 300 also permits customers to choose pick-up locations in advance (i.e. up to three months ahead). This type of arrangement allows the system 300 and its inventory to be prepared to meet the customer's needs. Customers are provided selection choices with regard to expiration dates that affect overall shipping costs and flex/behavior costs. Customers are provided better visibility into the products that they are purchasing a thus have a better shopping experience. Waste is reduced due to incentivized selling of products that are closer to expiration. Further, retailers can be additionally compensated for selling products with more distant expiration dates.

Any of the features and disclosures related to system 300 can be applied to the more generalized system 100 and related methods that are disclosed and discussed with respect to FIGS. 1 and 2.

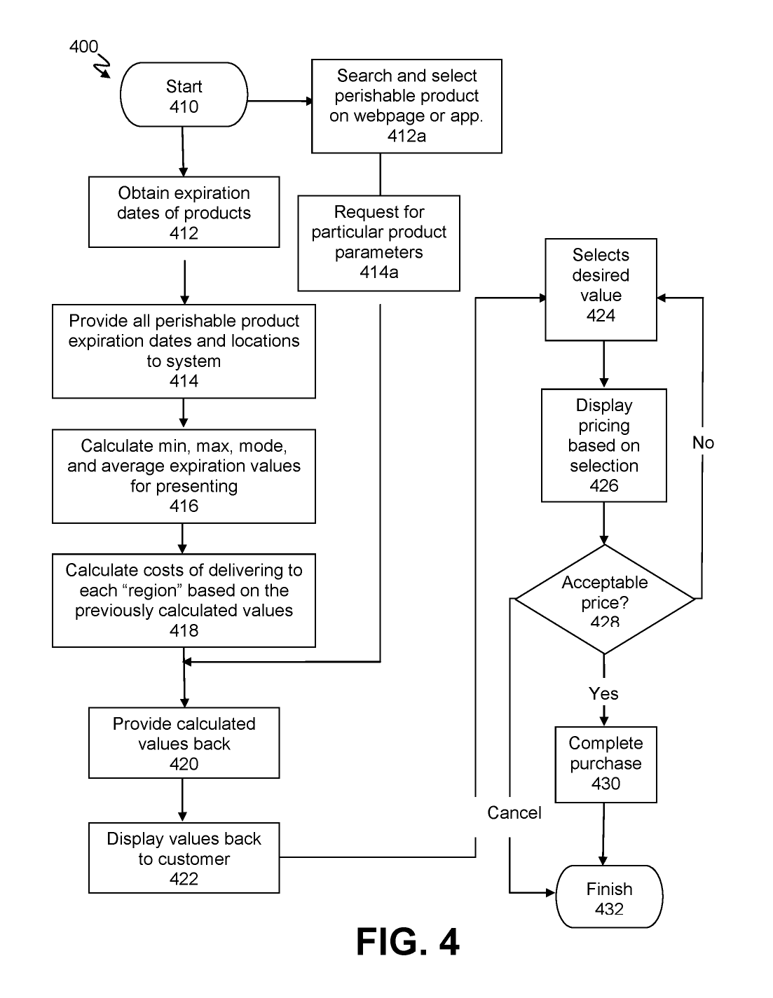

FIG. 4 shows a flowchart of a method 400 of providing dynamically discounted perishable foods and consumable products, that can be carried out on a system 300 (or system 100), for example. The method 400 begins at start 410, with a pair of actions. In one action, at 412, the system 314 obtains expiration dates of perishable products. In the other, at 412a a computing device, such as a mobile computing device 320, is used to search and select a perishable product on a website or app. This is followed by a web system 318 request, at 414a, via website, for particular product requirements. Concurrently, once expiration dates of perishable products are obtained at 412, at 414 the distribution center system 312 provides all perishable product expiration dates and locations to the system 314. At 416, the system 312 calculates the min, max, mode, and average expiration values for presenting. At 418, the system 312 calculates the cost of delivering to each “region” based on the previously calculated values. At 420, the system 312 provides calculated values back. At 422, the web site of the web system 318 displays values back to the customer. At 424, the customer selects the desired value. At 426, the website of the web system 318 displays pricing based on the selection. At 428, the customer responds to whether the price is acceptable. If no, the customer is asked to select a desired value again at 424. If the customer wishes to cancel, the system proceeds to the finish at 432. If the price is acceptable at 428, the customer completes the purchase at 430 and proceeds to finish at 432.

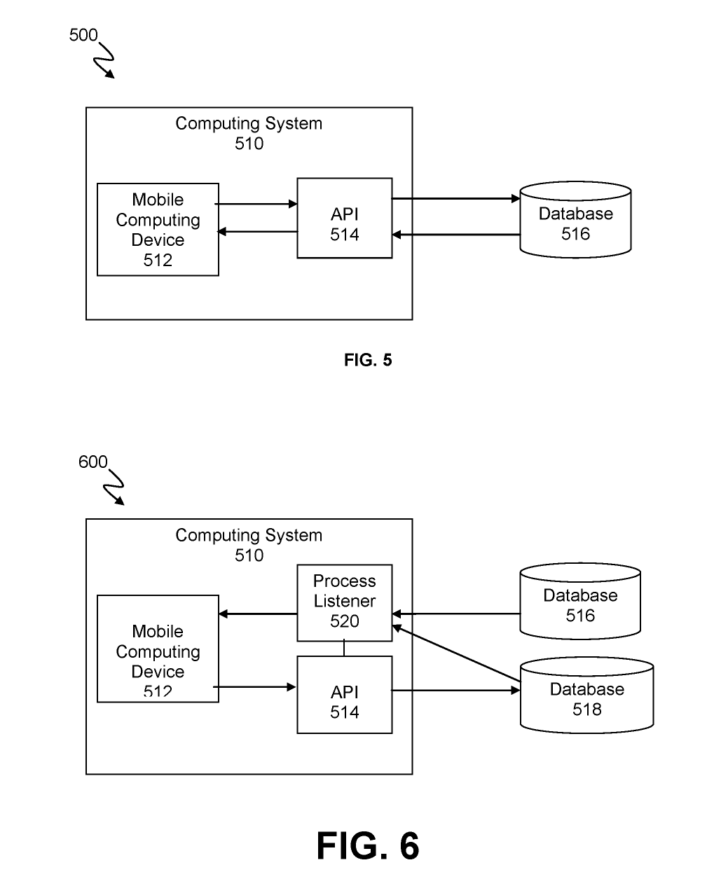

FIG. 5 shows a schematic diagram of a perishable product conservation system 500 which illustrates a particular example of a general arrangement for dynamically calculating prices for perishable products. The system includes a computing system 510, having a mobile computing device and an API 514, and a database 516. Each of the computing system 510, API 514 and database 516 being communicatively coupled with one another. In general, a customer first searches and selects a perishable product on the mobile computing device 512. Next, the API 514 retrieves and calculates cost options. Next, calculations are run daily via database 516 to determine feeding costs. Finally purchase preferences are stored in the database 516 for machine learning of customer preferences.

Similarly, FIG. 6 shows a corresponding example of a system 600 of a perishable product conservation system including alerting customers to desired perishable products. This arrangement is similar to FIG. 5, but further includes a database 518 and a process listener 520. In this arrangement, based on provided or learned customer preferences, the system listens for alertable changes via process listener 520. Notifications are send to the mobile computing device 512. The customer then responds on the mobile computing device 512 by buying or ignoring the notification and sending a response via API 514. Finally the API 514 is used to update the machine learning model on the database 518 based on the latest results.

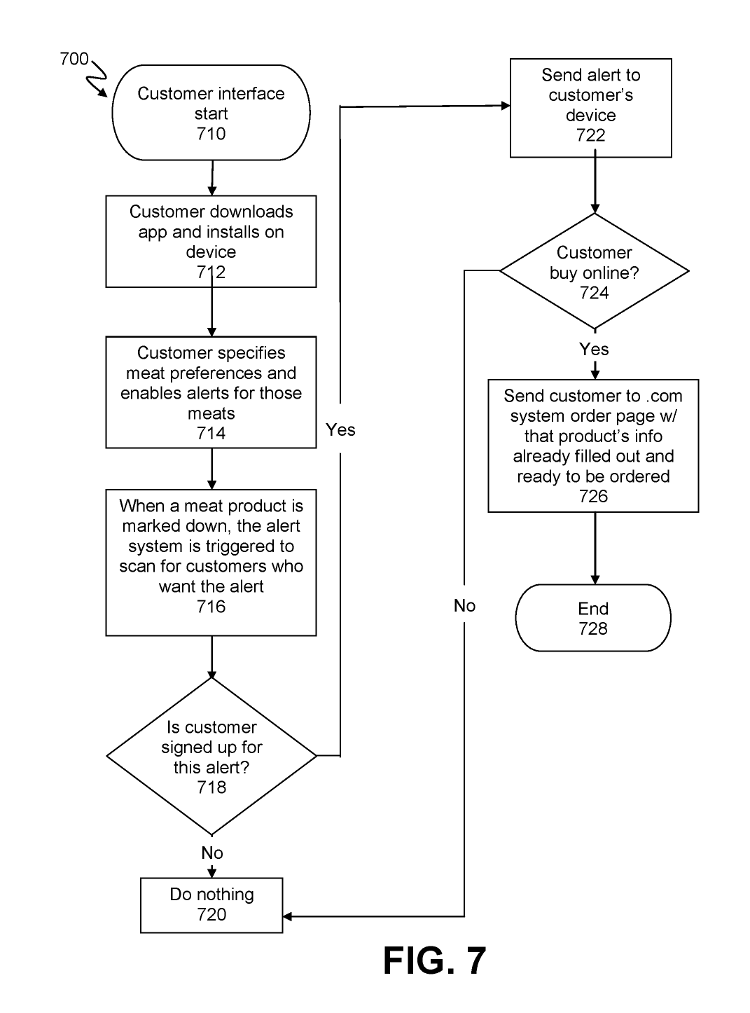

FIG. 7 shows a flowchart of a method 700 of providing dynamically discounted perishable foods and specifically, a markdown and alert system for fresh cut meats using a mobile app. While this example relates to meat markdowns and a mobile device, other perishable items and computing devices and user interfaces can be alternatively understood to be the subject of this process. In the case of discounted meats, customers generally do not know when meat is marked down until they come in to a store and happen to see the marked down meat. The systems and methods discussed, and particularly method 700, provides a system that utilizes an app with customer preferences to alert customers when their favorite meats have gone on discount or have been marked down. The system interfaces with Internet sites to allow those customers to then immediately purchase that marked down meat for pickup.

At 710, the customer begins the method with the interface of a mobile device. At 712, the customer downloads the app and installs it on the mobile device. This type of app can be made widely available for customers. At 714, the customer specifies meat preferences and enables alerts for those meats. Specifically, a customer can set up a user profile with store numbers(s), meat preferences, and to enable meat alerts. At 716, when a meat product is marked down, it triggers the alert system to scan for customers who want the alert. When a preferred meat goes on markdown, customers are alerted directly on their mobile device through the app. At 718, the mobile application asks whether the customer is signed up the particular alert. If not signed up, the mobile application does nothing, as shown at 720. If the user is signed up, an alert is sent to the customer's mobile device at 722. The customer is asked if he or she would like to buy the meat item online at 724. If no, the mobile application does nothing at 720. If an online purchase is desired, at 726, the customer is sent to a .com system with pre-filled out product information which is ready for placing an order. In cases where someone else beats the customer to an order, the website will stop the transaction and inform the customer that the discount is no longer available. Finally, completion of the process is indicated at 728.

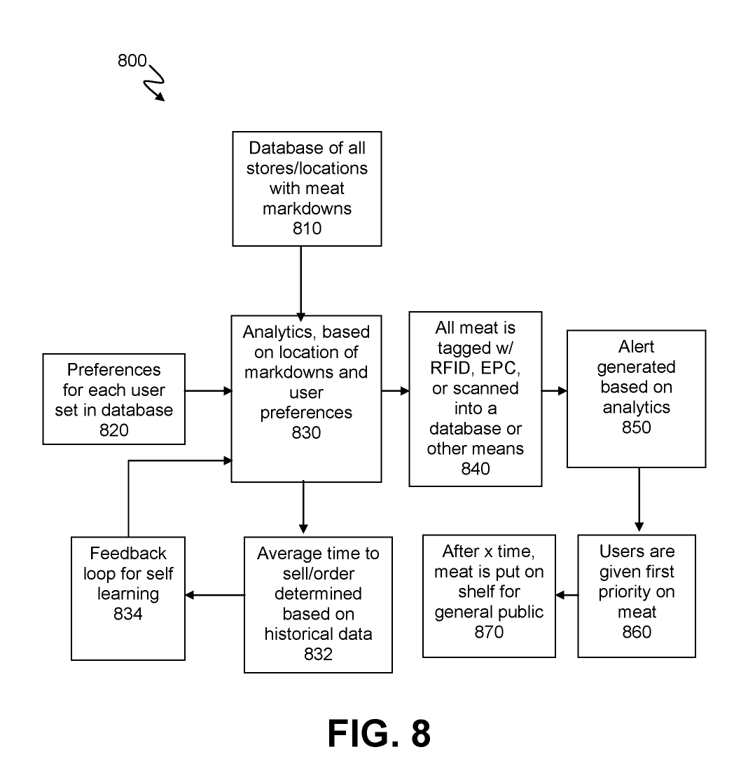

FIG. 8 shows a flowchart of a similar corresponding method 800 of providing dynamically discounted perishable foods and specifically a markdown and alert system for meats using a mobile app. While this example relates to meat markdowns and a mobile device, other perishable items and computing devices and user interfaces can be alternatively understood to be the subject of this process. At 810, a database of all stores and locations with meat markdowns is provided to an analytics engine. Similarly, at 820, preferences for each user are set in a database. At 830, analytics are performed based on the type, price, and location of markdowns and user preferences. At 832, average time to sell and/or order is determined based on historical data and, at 834, a feedback loop for self-learning is provided. In response to the analytics at 830, all meat is tagged with RFID or EPC and scanned into a database at 840. Next, at 850, an alert is generated based on analytics. At 860, users are given first priority at purchasing meat. At 870, meat is put on the shelf and offered to the general public.

In embodiments, systems and methods and/or their components disclosed in this application, can include computing devices, microprocessors, modules and other computer or computing devices, which can be any programmable device that accepts digital data as input, is configured to process the input according to instructions or algorithms, and provides results as outputs. In an embodiment, computing and other such devices discussed herein can be, comprise, contain or be coupled to a central processing unit (CPU) configured to carry out the instructions of a computer program. Computing and other such devices discussed herein are therefore configured to perform basic arithmetical, logical, and input/output operations.

Computing and other devices discussed herein can include memory. Memory can comprise volatile or non-volatile memory as required by the coupled computing device or processor to not only provide space to execute the instructions or algorithms, but to provide the space to store the instructions themselves. In embodiments, volatile memory can include random access memory (RAM), dynamic random access memory (DRAM), or static random access memory (SRAM), for example. In embodiments, non-volatile memory can include read-only memory, flash memory, ferroelectric RAM, hard disk, floppy disk, magnetic tape, or optical disc storage, for example. The foregoing lists in no way limit the type of memory that can be used, as these embodiments are given only by way of example and are not intended to limit the scope of the invention.

In embodiments, the system or components thereof can comprise or include various modules or engines, each of which is constructed, programmed, configured, or otherwise adapted, to autonomously carry out a function or set of functions. The term “engine” as used herein is defined as a real-world device, component, or arrangement of components implemented using hardware, such as by an application-specific integrated circuit (ASIC) or field-programmable gate array (FPGA), for example, or as a combination of hardware and software, such as by a microprocessor system and a set of program instructions that adapt the engine to implement the particular functionality, which (while being executed) transform the microprocessor system into a special-purpose device. An engine can also be implemented as a combination of the two, with certain functions facilitated by hardware alone, and other functions facilitated by a combination of hardware and software. In certain implementations, at least a portion, and in some cases, all, of an engine can be executed on the processor(s) of one or more computing platforms that are made up of hardware (e.g., one or more processors, data storage devices such as memory or drive storage, input/output facilities such as network interface devices, video devices, keyboard, mouse or touchscreen devices, etc.) that execute an operating system, system programs, and application programs, while also implementing the engine using multitasking, multithreading, distributed (e.g., cluster, peer-peer, cloud, etc.) processing where appropriate, or other such techniques. Accordingly, each engine can be realized in a variety of physically realizable configurations, and should generally not be limited to any particular implementation exemplified herein, unless such limitations are expressly called out. In addition, an engine can itself be composed of more than one sub-engines, each of which can be regarded as an engine in its own right. Moreover, in the embodiments described herein, each of the various engines corresponds to a defined autonomous functionality; however, it should be understood that in other contemplated embodiments, each functionality can be distributed to more than one engine. Likewise, in other contemplated embodiments, multiple defined functionalities may be implemented by a single engine that performs those multiple functions, possibly alongside other functions, or distributed differently among a set of engines than specifically illustrated in the examples herein.

Various embodiments of systems, devices, and methods have been described herein. These embodiments are given only by way of example and are not intended to limit the scope of the invention. It should be appreciated, moreover, that the various features of the embodiments that have been described may be combined in various ways to produce numerous additional embodiments. Moreover, while various materials, dimensions, shapes, configurations and locations, etc. have been described for use with disclosed embodiments, others besides those disclosed may be utilized without exceeding the scope of the invention.

Persons of ordinary skill in the relevant arts will recognize that the subject matter hereof may comprise fewer features than illustrated in any of the individual embodiments described above. The embodiments described herein are not meant to be an exhaustive presentation of the ways in which the various features of the subject matter herein may be combined. Accordingly, the embodiments are not mutually exclusive combinations of features; rather, the various embodiments can comprise a combination of different individual features selected from different individual embodiments, as understood by persons of ordinary skill in the art. Moreover, elements described with respect to one embodiment can be implemented in other embodiments even when not described in such embodiments unless otherwise noted.

Although a dependent claim may refer in the claims to a specific combination with one or more other claims, other embodiments can also include a combination of the dependent claim with the subject matter of each other dependent claim or a combination of one or more features with other dependent or independent claims. Such combinations are proposed herein unless it is stated that a specific combination is not intended.

Any incorporation by reference of documents above is limited such that no subject matter is incorporated that is contrary to the explicit disclosure herein. Any incorporation by reference of documents above is further limited such that no claims included in the documents are incorporated by reference herein. Any incorporation by reference of documents above is yet further limited such that any definitions provided in the documents are not incorporated by reference herein unless expressly included herein.

For purposes of interpreting the claims, it is expressly intended that the provisions of 35 U.S.C. § 112(f) are not to be invoked unless the specific terms “means for” or “step for” are recited in a claim.

1. A perishable product conservation system for foods and consumable products comprising:
a plurality of perishable products held in inventory;
a perishable product database comprising a plurality of product records for the plurality of perishable products, each of the plurality of product records including expiration date information and a current product location; and
a computing system communicatively coupled with the perishable product database, including:
a customer preference engine configured to identify a desired perishable product, a desired location for receiving purchases, and a set of customer tolerances for the desired perishable product including a desired expiration date range;
a markdown engine configured to provide dynamic pricing for the desired perishable product, available within the desired expiration date range, based on at least: the expiration date information, the current product location, and a shipping cost for transporting the perishable product to the desired location for receiving purchases;
a computing device communicatively interfacing with the customer preference engine and the markdown engine having hardware of at least one processor, a memory operably coupled to the at least one processor and configured to store instructions invoked by the at least one processor, an operating system implemented on the computing hardware, and a display generator for a customer interface configured to store a plurality of renderable structures defining a display of one or more user interface elements of a client interface, the display generating dynamic pricing information and graphics.

2. The perishable product conservation system of claim 1, wherein the customer preference engine relies on stored information from: a set of saved customer selected preferences, a set of saved past purchase information, or a set of customer preferences determined based on machine learning specific to a specific customer.

3. The perishable product conservation system of claim 2, further including an alert engine configured to monitor the perishable product database and generate an alert based on satisfaction of the set of customer tolerances and the dynamic pricing for the desired perishable product.

4. The perishable product conservation system of claim 3, wherein the alert engine includes a process listener.

5. The perishable product conservation system of claim 1, wherein the shipping cost is automatically assigned zero cost when the desired location for receiving purchases matches the current product location.

6. The perishable product conservation system of claim 1, wherein the dynamic pricing for the desired perishable product is also based on an expected disposal cost of the desired perishable product.

7. The perishable product conservation system of claim 1, wherein the dynamic pricing for the desired perishable product is also based on the past sales data of the perishable product.

8. The perishable product conservation system of claim 1, wherein the dynamic pricing for the desired perishable products is also based on a current or expected quantity of inventory.

9. The perishable product conservation system of claim 1, wherein customers purchase perishable products directly through the computing system.

10. The perishable product conservation system of claim 1, wherein the plurality of product records for the plurality of perishable products held in inventory include a recent photo of the perishable product.

11. The perishable product conservation system of claim 1, wherein the dynamic pricing includes a tiered structure of discounted pricing.

12. The perishable product conservation system of claim 1, wherein customers are permitted to reserve perishable products for later local purchase and pickup.

13. The perishable product conservation system of claim 1, wherein the plurality of perishable products can include fresh produce, meat, canned goods, and packaged items.

14. The perishable product conservation system of claim 1, wherein the expiration date information corresponds to one or more of: a “Sell-By” date, a “Sell-Before” date, a “Best-By” date, a “Best-Before” date, a “Best-If-Used-By” date, a “Best-If-Used-Before” date, a “Use-By” date, or a “Use-Before” date.

15. The perishable product conservation system of claim 1, wherein the expiration date information includes one or more of: a minimum value, a maximum value, a mode, an average value, or a combination thereof.

16. The perishable product conservation system of claim 1, wherein the computing system utilizes a mobile app.

17. The perishable product conservation system of claim 1, wherein the computing system utilizes an internet website.

18. A method of providing dynamically discounted perishable foods and consumable products comprising:
providing a perishable product database comprising a plurality of product records for a plurality of perishable products held in inventory, each of the plurality of product records including expiration date information and a current product location;
providing a computing system, including a customer preference engine, a markdown engine, and a computing device, communicatively coupled with the perishable product database;
receiving a customer request in the customer preference engine for a desired perishable product, a desired location for receiving purchases, and a set of customer tolerances for the desired perishable product including a desired expiration date range;
searching the perishable product database for perishable products corresponding to the desired perishable product that meet the set of customer tolerances;
calculating a dynamic price with the markdown engine for the desired perishable product including a cost to ship the desired perishable product to the desired location; and
presenting the dynamic price of the desired perishable product with an option to purchase on the computing device.

19. The method of claim 18, further including enabling customer modification and storage of a set of customer selected preferences for: the desired perishable product, the desired location for receiving purchases, the set of customer tolerances for the desired perishable product including the desired expiration date range and price.

20. The method of claim 19, further including establishing an alert engine to monitor the perishable product database and generating an alert when the customer selected preferences are satisfied.

21. The method of claim 18, wherein calculating the dynamic price includes consideration of an expected disposal cost of the desired perishable product.

22. The method of claim 18, wherein calculating the dynamic price includes consideration of the past sales data of the perishable product.

23. The method of claim 18, wherein calculating the dynamic price includes consideration of current or expected quantity of inventory of the perishable product.

24. The method of claim 18, wherein the plurality of product records for the plurality of perishable products held in inventory include a recent photo of the perishable product.

25. The method of claim 18, wherein presenting the dynamic price of the desired perishable product includes presentation of a tiered structure of discounted pricing.

26. The method of claim 18, wherein the expiration date information includes one or more of: a minimum value, a maximum value, a mode, an average value, or a combination thereof.

27. The method of claim 18, wherein when the cost to ship the desired perishable product is automatically assigned zero cost when the current product location and the desired location match.

28. The method of claim 18, wherein the computing system utilizes a mobile app.

29. The method of claim 18, wherein the computing system utilizes an internet website.
